(19) United States
(12) Patent Application Publication
(10) Pub. No.: US 2024/0217742 A1
(43) Pub. Date: Jul. 4, 2024

(54) METHOD AND APPARATUS FOR SEQUENTIALLY ARRANGING ITEMS DISCHARGED IN RANDOM ORDER AND DISCHARGING SAME AGAIN

(71) Applicant: Gachisoft Inc., Daejeon (KR)

(72) Inventor: Ho Yon KIM, Sejong (KR)

(73) Assignee: Gachisoft Inc., Daejeon (KR)

(21) Appl. No.: 18/286,649

(22) PCT Filed: Sep. 30, 2021
(86) PCT No.: PCT/KR2021/013423

§ 371 Date: Oct. 12, 2023

(30) Foreign Application Priority Data
Apr. 13, 2021 (KR) 10-2021-0047860
Sep. 30, 2021 (KR) 10-2021-0129414

(51) Int. Cl. B65G 1/04

(52) U.S. Cl. CPC B65G 1/0485; B65G 2203/0216

(57) ABSTRACT

A method and an apparatus for sequentially arranging items or objects discharged in a random order and discharging same again are disclosed. A method for sequentially arranging items discharged in a random order and discharging same again according to an embodiment comprises the steps of: receiving items discharged in a random order and recognizing a discharge order attached to or printed on the items; grouping the items into a predetermined number unit according to the discharge order, allocating and preparing in advance a different loading position of each group, and sequentially loading the items of the recognized discharge order at a loading position allocated to a group corresponding to the recognized discharge order of the items provided sequentially; and when a predetermined condition is satisfied in at least one loading position, arranging items in the discharge order of the items loaded at the corresponding loading position and then discharging the items one by one from the corresponding loading position.

### TECHNICAL FIELD

The present invention relates to logistics technology, and to a method and apparatus for sequentially arranging items or objects discharged in a random order and discharging them again.

### BACKGROUND ART

To produce finished products in automated or semi-automated manufacturing facilities, numerous components are required, and these components need to be supplied in sequence according to the assembly process. Typically, the components required for assembly are withdrawn from their storage location or discharged from a separate supply unit and conveyed on a transfer line, such as a conveyor. However, since the order of discharge is not consistent, they cannot be immediately introduced into the assembly process and must be rearranged and supplied in the required order for assembly.

Therefore, a sorting process is required to arrange multiple components in sequence, which can interrupt the flow of the assembly process. Additionally, a considerable amount of space may be needed for sorting, or if the number of components increases, the configuration or algorithm for sorting may become complex.

Furthermore, the need for technology that rearranges and discharges items after this sequence rearrangement is essential not only in the case of component supply in the assembly process but also for general goods.

### DISCLOSURE

### Technical Problem

According to one embodiment, there is proposed a method and apparatus for initially classifying items that are discharged in a random order, temporarily storing them, and then, when predetermined conditions are met, supplying them by arranging them in sequence within the initially classified range.

### Technical Solution

A method for sequentially arranging items discharged in a random order and discharging same again according to an embodiment comprises the steps of: receiving items discharged in a random order and recognizing a discharge order attached to or printed on the items; grouping the items into a predetermined number unit according to the discharge order, allocating and preparing in advance a different loading position of each group, and sequentially loading the items of the recognized discharge order at a loading position allocated to a group corresponding to the recognized discharge order of the items provided sequentially; and when a predetermined condition is satisfied in at least one loading position, arranging items in the discharge order of the items loaded at the corresponding loading position and then discharging the items one by one from the corresponding loading position.

The predetermined condition may be a case where the number of loading positions at which items are loaded in each group, including the loading position of the group with the earliest discharge order, is greater than or equal to a predetermined number.

The arranging and discharging of the items in the order of discharge may include, once all items have been loaded into a loading position allocated to a group with the earliest discharge order, arranging the items in the discharge order of the items within a loading position of the corresponding group and discharging the items one by one from a loading position with the earliest discharge order.

An apparatus for arranging in sequence items discharged in a random order and discharging them again may include: a recognizing part configured to receive items discharged in a random order and recognize a discharge order attached to or printed on the items; a group-specific loading part configured to group the items into a predetermined number unit according to the discharge order, allocate and prepare in advance a different loading position of each group, and sequentially load the items of the recognized discharge order at a loading position allocated to a group corresponding to the recognized discharge order of the items provided sequentially; and an arranging part configured to, when a predetermined condition is satisfied in at least one loading position, arrange items in the discharge order of the items loaded at the corresponding loading position and then discharge the items one by one from the corresponding loading position.

### Advantageous Effects

According to one embodiment, it is possible to process items efficiently with minimal space occupancy and high speed by initially classifying them into groups, temporarily storing them, and then arranging and discharging them in sequence within their respective group-specific classified range while moving them using a buffer or the like.

### DESCRIPTION OF DRAWINGS

FIG. 1 is a simplified block diagram illustrating a configuration of an apparatus for arranging in sequence items discharged sequentially in a random order and discharging them again according to an embodiment of the present invention;

FIG. 2 is a reference diagram illustrating the loading of items into a group-specific loading part of the apparatus according to an embodiment of the present invention when the items are supplied in a random order;

FIG. 3 is a reference diagram illustrating an example where items are discharged again for arrangement when a predetermined condition is satisfied after the items have been loaded into the group-specific loading part of the apparatus according to an embodiment of the present invention;

FIG. 4 is a reference diagram illustrating a first embodiment in which items discharged from the group-specific loading part are rearranged and discharged by the arranging part of the apparatus according to an embodiment of the present invention;

FIG. 5 is a reference diagram for explaining a second embodiment in which items discharged from the group-specific loading part are rearranged and discharged from an arranging part of the apparatus according to an embodiment of the present invention; and

FIG. 6 is a flowchart illustrating a method for arranging in sequence items discharged sequentially in a random order and discharging them again according to an embodiment of the present invention.

### MODES OF THE INVENTION

The aspects and features of the present invention and methods for achieving the aspects and features will be apparent by referring to the example embodiments to be described in detail with reference to the accompanying drawings. However, the present invention is not limited to the example embodiments disclosed hereinafter, but can be implemented in various different forms. The example embodiments are merely provided so that the present invention is thorough and complete, and fully conveys the scope of the present invention to those skilled in the art, and the present invention is only defined within the scope of the appended claims. Throughout the entire specification, the same or like reference numerals designate the same or like elements.

In describing the example embodiments, a detailed description of related known configurations or functions incorporated herein will be omitted when it is determined that the detailed description thereof may unnecessarily obscure the subject matter of the present invention. The terms which will be described below are terms defined in consideration of the functions in the present invention, and may be different according to users, intentions of the users, or customs. Therefore, the definitions of the terms should be made based on the contents throughout the specification.

Combinations of blocks in the accompanying block diagrams or steps in the accompanying flowcharts can be executed by computer program instructions (execution engine), and the computer program instructions can be mounted in a processor of a general-use computer, special-use computer or other programmable data processing equipment. Thus, the instructions executed through the processor of the computer or other programmable data processing equipment generate a means for performing the functions described in the respective blocks of the block diagrams or the respective steps of the flowcharts.

The computer program instructions can be stored in a computer usable or readable memory oriented to a computer or other programmable data processing equipment, in order to implement functions in a specific method. Thus, the instructions stored in the computer usable or readable memory can be used to manufacture products including instruction units for performing the functions described in the respective blocks of the block diagrams or the respective steps of the flowcharts.

In addition, the computer program instructions can be mounted in the computer or other programmable data processing equipment. Therefore, instructions which generate processes by performing a series of operation steps on the computer or other programmable data processing equipment and operate the computer or other programmable data processing equipment can provide steps for executing the functions described in the respective blocks of the block diagrams and the respective steps of the flowcharts.

Further, each of the blocks or steps may indicate a part of a module, segment or code including one or more executable instructions for executing specific logical functions. In some substitutions, the functions described in the blocks or steps can be performed out of sequence. For example, two blocks or steps shown in succession may in fact be substantially executed at the same time, and the two blocks or steps may also be executed in the reverse order of the corresponding function as necessary.

Hereinafter, example embodiments of the present invention will be described in detail with reference to the accompanying drawings. However, the example embodiments may be modified in various different forms, and the scope of the present invention is not limited to the example embodiments described below. The example embodiments are provided to more completely describe the present invention to those skilled in the art.

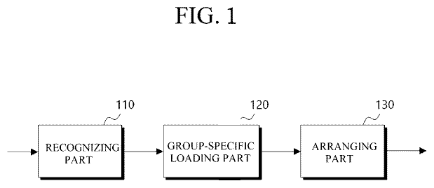

FIG. 1 is a simplified block diagram illustrating a configuration of an apparatus for arranging in sequence items discharged sequentially in a random order and discharging them again according to an embodiment of the present invention.

An apparatus for arranging and discharging items according to an embodiment of the present invention may include a recognizing part 110, a group-specific loading part 120, and an arranging part 130. The recognizing part 110 receives items discharged sequentially in a random order and recognizes a discharge order attached or printed on the received items. The discharge order attached or printed on the item may be recognized through various means, such as symbols, numbers, characters, barcodes, wireless tags, and the like. Thus, the recognizing part 110 may be configured in various forms, such as video recording means including cameras, wireless tag recognition means, and the like.

The group-specific loading part 120 groups the items into a predetermined number unit according to the discharge order, allocates and prepares in advance a different loading position of each group, and sequentially loads the items of the recognized discharge order at a loading position allocated to a group corresponding to the recognized discharge order of the items provided sequentially.

When a predetermined condition is satisfied in at least one loading position, the arranging part 130 arranges the items in the discharge order of the items loaded at the corresponding loading positions and then discharges the items one by one from the corresponding loading positions. For example, when the number of loading positions at which items are loaded in each group, including the loading position of the group with the earliest discharge order, is greater than or equal to a predetermined number, items loaded at the corresponding loading positions may be discharged and rearranged in the discharge order, and then discharged again. In other words, once all items have been loaded into the loading position allocated to the group with the earliest discharge order in the group-specific loading part 120, the items are arranged in the discharge order of the items within a loading position of the corresponding group and discharged one by one from a loading position with the earliest discharge order.

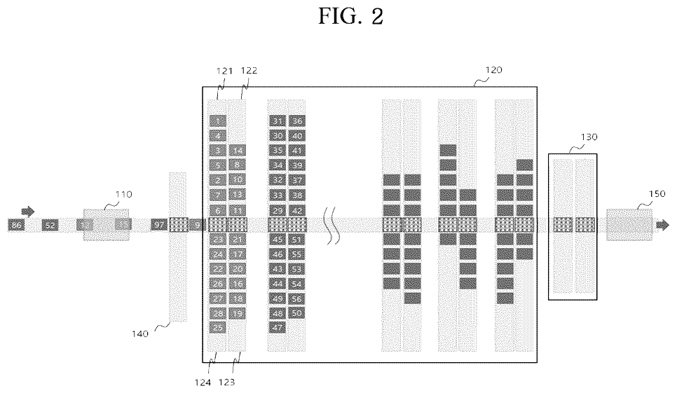

For this purpose, the arranging part 130 may be provided with a plurality of buffers, and by changing the discharge order of the items by relocating or moving them to the buffers at different positions according to the discharge order, it rearranges the items in the discharge order within the corresponding group, and discharges them. More detailed description of sequence arrangement and discharge process will be provided hereinafter with reference to FIGS. 2 to 4.

FIG. 2 is a reference diagram illustrating the loading of items into the group-specific loading part of the apparatus according to an embodiment of the present invention when the items are supplied in a random order.

When items with a predetermined order to be arranged are supplied in a random order along a transfer line, the recognizing part 110 first recognizes the predetermined order. Then, the items are grouped into a predetermined number unit according to the discharge order and a different loading position of each group is allocated and prepared in advance. Referring to the example shown in FIG. 2, if items are grouped in sets of 7, a first loading position 121 is allocated to items 1 to 7, a second loading position 122 is allocated to items 8 to 14, a third loading position 123 is allocated to items 15 to 21, and a fourth loading position 124 is allocated to items 23 to 28. When items are sequentially supplied, the items of the recognized discharge order are sequentially loaded at a loading position allocated to a group corresponding to the recognized discharge order of the items supplied. In the example in FIG. 2, items are loaded into the first loading position 121 in the order of 1-4-3-5-2-7-6. Similarly, items are loaded into the second loading position 122 in the order of 14-8-10-13-11, and it can be inferred that items with the number from 9 to 12 will continue to be loaded at this position 122 when supplied. Therefore, the item currently in transit, item 9, will be loaded into the second loading position 122.

In this way, each item with recognized discharge order is initially loaded into the loading position of the group to which it belongs. Within each loading position 121, 122, 123, and 124, the loading order of items varies according to the discharge order of the supplied items, resulting in random arrangements within the corresponding group. The items with the mixed order will be arranged and discharged in sequence by the arranging part 130.

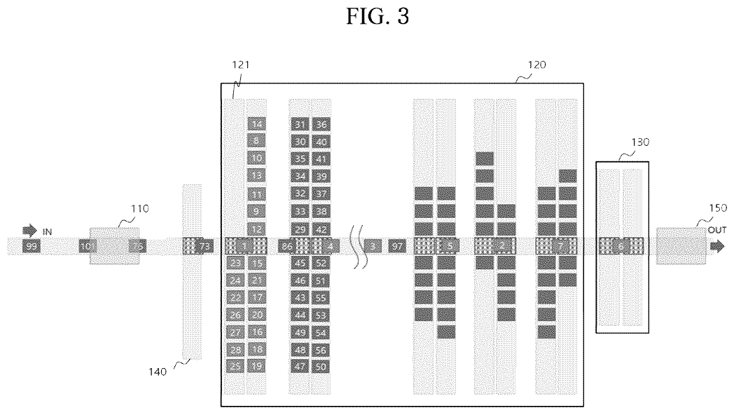

FIG. 3 is a reference diagram illustrating an example where items are discharged again for arrangement when a predetermined condition is satisfied after the items have been loaded into the group-specific loading part of the apparatus according to an embodiment of the present invention.

When a predetermined condition is satisfied in at least one loading position, for example, when items are fully loaded at the loading position 121 with the earliest discharge order or when the loading of items is completed at all four loading positions 121, 122, 123, and 124, items are discharged one by one from the loading position 121 with the earliest discharge order. In the example shown in FIG. 3, items loaded into the first loading position 121 are discharged in the order of 6-7-2-5-3-4-1, which is the reverse order of their loading. Meanwhile, during this discharge process, the supply of items may continue. In the example shown in FIG. 3, item 97 may be inserted between items 5 and 3, and item 97 is also loaded into the loading position of its corresponding group.

The predetermined condition here is not limited to the number of fully loaded loading positions but may vary depending on the number of supplied items.

Additionally, the unit number for grouping is not limited to 7, the number of loading positions for each group is not limited to 4, and the arrangement of loading positions may be on both sides or on one side. Furthermore, while FIGS. 2 and 3 illustrate the supply and discharge lines of items as a single line, they may be configured separately in different locations.

Additionally, a temporary storage part 140 may be further provided to temporarily store items when items with a discharge order beyond the processing range of the group-specific loading part 120 are recognized during the sorting process.

In addition, a confirming part 150 may be further provided to confirm whether items are correctly discharged according to the final arranged discharge order from the arranging part 130. The same technology as the recognizing part 110 may be applied to the confirming part 150.

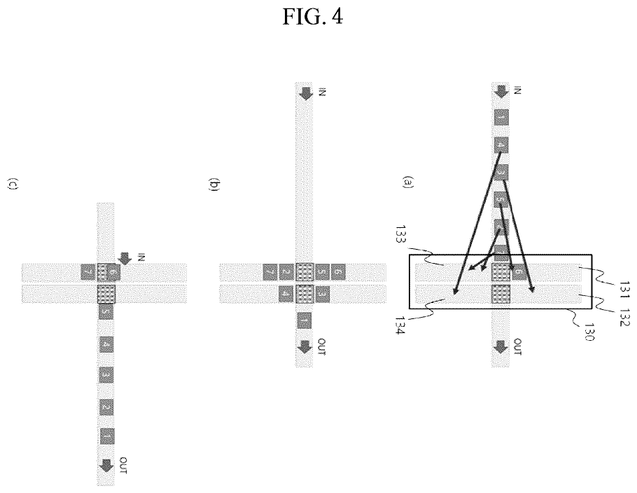

FIG. 4 is a reference diagram illustrating a first embodiment in which items discharged from the group-specific loading part are rearranged and discharged by the arranging part of the apparatus according to an embodiment of the present invention.

The arranging part 130 is provided with a plurality of buffers 131, 132, 133, and 134, and rearranges and discharges items in the discharge order within the corresponding group by changing the discharge order of the items by reloading into or moving them to the buffers at different positions according to the discharge order. In the example shown in FIG. 4, when items loaded into the first loading position 121 are discharged, items 1 to 7 may be positioned in buffers 131, 132, 133, and 134 sequentially and discharged according to the discharge order.

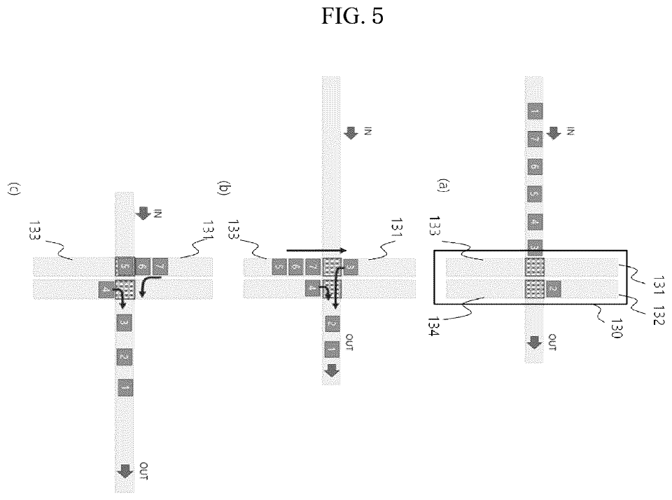

FIG. 5 is a reference diagram illustrating a second embodiment in which items discharged from the group-specific loading part are rearranged and discharged by the arranging part of the apparatus according to an embodiment of the present invention.

Depending on the order in which items enter the arranging part 130, in addition to simply positioning items in buffers, as shown in the example in FIG. 5, there may be cases where items need to be moved from one buffer to another. Referring to FIG. 5, to discharge item 5 after item 4, items 7 and 6, which are initially located in the buffer 133, are moved to another buffer 131 to allow item 5 to be discharged from the buffer 133 after item 4.

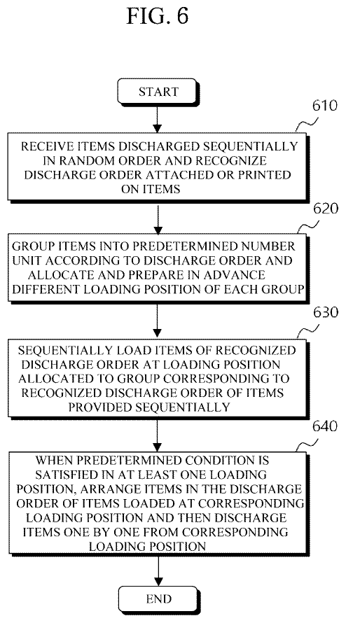

FIG. 6 is a flowchart illustrating a method for arranging in sequence items discharged sequentially in a random order and discharging them again according to an embodiment of the present invention.

First, items discharged sequentially in a random order are received, and a discharge order attached to the items is recognized in 610. The discharge order attached or printed on the item may be recognized through various means, such as symbols, numbers, characters, barcodes, wireless tags, and the like. Thus, configurations in various forms, such as video recording means including cameras, wireless tag recognition means, and the like, may be used.

Then, the items are grouped into a predetermined number unit according to the discharge order and a different loading position of each group is allocated and prepared in advance in 620.

Thereafter, the items of the recognized discharge order are sequentially loaded at a loading position allocated to a group corresponding to the recognized discharge order of the items supplied sequentially in 630.

When a predetermined condition is satisfied in at least one loading position, the items are arranged in the discharge order of the items loaded at the corresponding loading positions and then discharges the items one by one from the corresponding loading positions in 640. For example, when the number of loading positions at which items are loaded in each group, including the loading position of the group with the earliest discharge order, is greater than or equal to a predetermined number, items loaded at the corresponding loading positions may be discharged and rearranged in the discharge order, and then discharged again. In other words, when all items have been loaded into the loading position allocated to the group with the earliest discharge order, the items are discharged one by one from the loading position with the earliest discharge order while rearranging the items in the discharge order within the loading position of the corresponding group. The description of the sequence arrangement and discharge process is the same as provided above with reference to FIGS. 2 to 4.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

1. A method for sequentially arranging items discharged in a random order and discharging same, the method comprising the steps of:
receiving items discharged in a random order and recognizing a discharge order attached to or printed on the items;
grouping the items into a predetermined number unit according to the discharge order, allocating and preparing in advance a different loading position of each group, and sequentially loading the items of the recognized discharge order at a loading position allocated to a group corresponding to the recognized discharge order of the items provided sequentially; and
when a predetermined condition is satisfied in at least one loading position, arranging items in the discharge order of the items loaded at the corresponding loading position and then discharging the items one by one from the corresponding loading position.

2. The method of claim 1, wherein the predetermined condition is a case where the number of loading positions at which items are loaded in each group, including the loading position of the group with the earliest discharge order, is greater than or equal to a predetermined number.

3. The method of claim 1, wherein the arranging and discharging of the items in the order of discharge comprises, once all items have been loaded into a loading position allocated to a group with the earliest discharge order, arranging the items in the discharge order of the items within a loading position of the corresponding group and discharging the items one by one from a loading position with the earliest discharge order.

4. The method of claim 1, wherein the arranging and discharging of the items in the discharge order comprises arranging the items in the discharge order within the corresponding group by changing the discharge order of the items by relocating or moving the items to buffers at different positions according to the discharge order and discharging the items one by one from the corresponding loading position.

5. The method of claim 1, wherein the recognizing of the discharge order of the items comprises recognizing the discharge order by reading at least one of symbols, numbers, characters, barcodes, and wireless tags attached or printed on the items.

6. An apparatus for arranging in sequence items discharged in a random order and discharging them again, comprising:
a recognizing part configured to receive items discharged in a random order and recognize a discharge order attached to or printed on the items;
a group-specific loading part configured to group the items into a predetermined number unit according to the discharge order, allocate and prepare in advance a different loading position of each group, and sequentially load the items of the recognized discharge order at a loading position allocated to a group corresponding to the recognized discharge order of the items provided sequentially; and
an arranging part configured to, when a predetermined condition is satisfied in at least one loading position, arrange items in the discharge order of the items loaded at the corresponding loading position and then discharge the items one by one from the corresponding loading position.

7. The apparatus of claim 6, wherein the predetermined condition is a case where the number of loading positions at which items are loaded in each group, including the loading position of the group with the earliest discharge order, is greater than or equal to a predetermined number.

8. The apparatus of claim 6, wherein the group-specific loading part is configured to once all items have been loaded into a loading position allocated to a group with the earliest discharge order, arrange the items in the discharge order of the items within a loading position of the corresponding group and discharge the items one by one from a loading position with the earliest discharge order.

9. The apparatus of claim 6, wherein the arranging part is configured to arrange the items in the discharge order within the corresponding group by changing the discharge order of the items by reloading or moving the items to buffers at different positions according to the discharge order and discharge the items one by one from the corresponding loading position of the group-specific loading part.

10. The apparatus of claim 6, wherein the recognizing part is configured to recognize the discharge order of the items by reading at least one of symbols, numbers, characters, barcodes, and wireless tags attached or printed on the items.

11. The method of claim 2, wherein the arranging and discharging of the items in the discharge order comprises arranging the items in the discharge order within the corresponding group by changing the discharge order of the items by relocating or moving the items to buffers at different positions according to the discharge order and discharging the items one by one from the corresponding loading position.

12. The method of claim 3, wherein the arranging and discharging of the items in the discharge order comprises arranging the items in the discharge order within the corresponding group by changing the discharge order of the items by relocating or moving the items to buffers at different positions according to the discharge order and discharging the items one by one from the corresponding loading position.

13. The apparatus of claim 7, wherein the arranging part is configured to arrange the items in the discharge order within the corresponding group by changing the discharge order of the items by reloading or moving the items to buffers at different positions according to the discharge order and discharge the items one by one from the corresponding loading position of the group-specific loading part.

14. The apparatus of claim 8, wherein the arranging part is configured to arrange the items in the discharge order within the corresponding group by changing the discharge order of the items by reloading or moving the items to buffers at different positions according to the discharge order and discharge the items one by one from the corresponding loading position of the group-specific loading part.
